(19) United States
(12) Patent Application Publication
(10) Pub. No.: US 2025/0117166 A1
(43) Pub. Date: Apr. 10, 2025

(54) PRINT SYSTEM, WORKFLOW PLATFORM, AND CONTROL METHOD OF PRINT SYSTEM

(71) Applicant: CANON KABUSHIKI KAISHA, Tokyo (JP)

(72) Inventor: HOSHITO MINAGI, Kanagawa (JP)

(21) Appl. No.: 18/818,758

(22) Filed: Aug. 29, 2024

(30) Foreign Application Priority Data
Oct. 4, 2023 (JP) 2023-173182

(51) Int. Cl. G06F 3/12

(52) U.S. Cl. CPC G06F 3/1207; G06F 3/1275

(57) ABSTRACT

A print system that performs printing from a workflow comprising: a workflow platform that executes the workflow; a chat service that provides notification to a user; and a print service that performs printing by a printer, wherein the workflow platform has at least one processor or circuit configured to function as: a workflow construction unit configured to construct the workflow in cooperation with the chat service and the print service, and a workflow execution unit configured to execute the workflow, and wherein the workflow execution unit executes printing by the print service according to the workflow to be executed, and provides notification of a result of printing executed by the print service by the chat service.

### BACKGROUND OF THE INVENTION

### Field of the Invention

The present invention relates to a print system, a workflow platform, and a control method of the print system.

### Description of the Related Art

In recent years, chat services and cloud services have been increasingly used. For example, there is a workflow platform that enables a user to construct a workflow combining various in-house services or various external online services from a chat service and automate tasks. The above-described workflow platform also provides a means for external online services to be added by users and third-party developers.

In contrast, printing is also performed by a printer in cooperation with a workflow. The user is also notified of the print execution result by the printer. Japanese Patent Laid-Open No. 2019-200600 discloses a unit that manages a print operation log by exceptional processing in a printer, a unit that acquires permission/prohibition of printing based on the print log, and a unit that provides a notification to a management user in a case where printing is not permitted.

### SUMMARY OF THE INVENTION

A print system according to an embodiment of the present invention is a print system that performs printing from a workflow comprising: a workflow platform that executes the workflow; a chat service that provides notifications to a user; and a print service that performs printing by a printer, wherein the workflow platform has at least one processor or circuit configured to function as: a workflow construction unit configured to construct the workflow in cooperation with the chat service and the print service, and a workflow execution unit configured to execute the workflow, and wherein the workflow execution unit executes printing by the print service according to the workflow to be executed, and provides notification of a result of printing executed by the print service by the chat service.

Further features of the present invention will become apparent from the following description of embodiments with reference to the attached drawings.

### BRIEF DESCRIPTION OF THE DRAWINGS

FIG. 1 is a diagram showing an overall configuration of a system according to the first embodiment of the present invention.

FIG. 2 is a hardware configuration diagram of a printer according to the first embodiment of the present invention.

FIG. 3 is a hardware configuration diagram of a client PC, a workflow platform, and a print service according to the first embodiment of the present invention.

FIG. 4 is a software configuration diagram of a system according to the first embodiment of the present invention.

FIG. 5 is a software configuration diagram of a system according to the first embodiment of the present invention.

FIG. 6 is a software configuration diagram of a system according to the first embodiment of the present invention.

FIG. 7 is a diagram showing a workflow list screen displayed on a chat service in the system according to the first embodiment of the present invention.

FIG. 8 is a diagram showing a screen for setting a trigger of a workflow displayed on a chat service in the system according to the first embodiment of the present invention.

FIG. 9 is a diagram showing a screen for setting an action of the workflow displayed on the chat service in the system according to the first embodiment of the present invention.

FIG. 10 is a diagram showing a screen for setting details of a trigger or an action of the workflow displayed on the chat service in the system according to the first embodiment of the present invention.

FIG. 11 is a flowchart showing a file trigger setting processing according to the first embodiment of the present invention.

FIG. 12 is a flowchart showing the processing of setting a file acquisition action according to the first embodiment of the present invention.

FIG. 13 is a flowchart of the workflow platform showing a print action according to a first embodiment of the present invention.

FIG. 14 is a flowchart of a print service showing the print action according to the first embodiment of the present invention.

FIG. 15 is a flowchart of the workflow platform showing a hold printing action according to the first embodiment of the present invention.

FIG. 16 is a flowchart of the workflow platform showing a notification action according to the first embodiment of the present invention.

FIG. 17 is a flowchart of the workflow platform during execution of the workflow according to the first embodiment of the present invention.

FIG. 18 is a flowchart of a print service during execution of the workflow according to the first embodiment of the present invention.

FIG. 19 is a flowchart of printing performed by a printer during execution of the workflow according to the first embodiment of the present invention.

FIG. 20 is a flowchart of hold printing performed by the printer during execution of the workflow according to the first embodiment of the present invention.

FIG. 21 is a flowchart of sending and receiving a notification request by a chat service during execution of the workflow according to the first embodiment of the present invention.

FIG. 22 is a flowchart of notification by the print service during execution of the workflow according to the first embodiment of the present invention.

FIG. 23 is a flowchart of notification by the print service during execution of workflow according to the first embodiment of the present invention.

FIG. 24 is a flowchart in which a print service determines a notification destination during execution of the workflow according to the first embodiment of the present invention.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

Note that in Japanese Patent Laid-Open No. 2019-200600 mentioned above, the time point of notification is a case where exceptional processing is performed, and a case where notification is necessary when printing is successful is not assumed. However, in printing in a workflow, since various jobs related to a document are automated and executed, there are cases in which a time point at which printing is actually performed may be different from a time point at which a user starts the workflow.

In this case, even if the printing is successful, the user needs to periodically check the progress of the workflow in order to start a post-process operation using the printed material, which hinders automation. Therefore, there is room for improvement in the configuration for smoothly advancing the workflow. In the following embodiments, the point as described above is improved.

### First Embodiment

### <Overall Configuration>

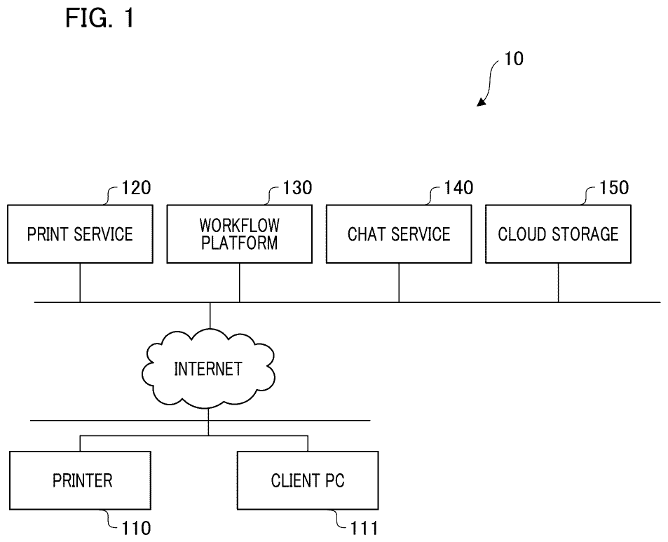

FIG. 1 is a diagram showing an overall configuration of a system according to the first embodiment of the present invention. The workflow system 10 has a workflow platform 130, a print service 120, a chat service 140, a cloud storage 150, a printer 110, and a client PC 111.

PC is an abbreviation for “Personal Computer”. The workflow platform 130, the print service 120, and the chat service 140 may be separate computers, or at least one of them may be the same computer.

The workflow system 10 is an example of a print system. The print service 120 and the chat service 140 are examples of online services.

The printer 110 and the client PC 111 are communicably connected to a server that provides various services on the Internet via a LAN. LAN is an abbreviation for “Local Area Network”.

The workflow platform 130 is a service that allows users to construct workflows. The workflow platform 130 is a service provided by an OS developer and the like, and can construct a workflow in cooperation with a service, for example, a cloud storage and a chat service provided by the OS developer and the like. OS is an abbreviation for “Operating System”.

Note that the workflow is data for executing actions, which are individual processes, in a predetermined order. The action is, for example, processing for printing performed by the printer 110 and the like, processing for hold printing performed by the printer 110 and the like, and processing for scanning performed by the printer 110 and the like.

Processing related to printing, such as processing for printing performed by the printer 110 and the like, and processing for hold printing performed by the printer 110 and the like, may be referred to as a print action. Processing related to scanning, such as processing for scanning processing by the printer 110 and the like, may be referred to as a scan action.

The action is not limited to processing related to printing or scanning, and may be processing that does not involve an image processing apparatus including the printer 110, such as an approval request, a notification request, file saving, conditional branch, and repeat processing.

Additionally, the workflow platform 130 has a customization function of cooperating with an online service provided by another company. As a result, according to the workflow platform 130, it is possible to create a workflow in cooperation with many services.

The print service 120 connects to the printer 110 and provides a service for receiving an image file scanned by the printer 110. The print service 120 provides a service for transferring a file to a service capable of storing a file such as a storage service.

The print service 120 provides a service of transmitting a file from a storage service and the like, a file from the client PC 111, and a print job to the printer 110 and printing them by the printer 110. The print service 120 is an online service.

The chat service 140 is a communication service for chatting. The chat service 140 cooperates with the workflow platform 130, and can provide a notification to the user by chat.

The chat service 140 is not limited to a service for performing a chat, and may have a function of providing a notification by a mail, an approval system, a task management system, and the like. Additionally, these services for providing the function of providing a notification to the user may be independent services.

The cloud storage 150 is a service capable of storing a file via the Internet and acquiring a file with a web browser.

The client PC 111 is a client PC for displaying and operating the services of the workflow platform 130. The user can use each service through a web browser or an application operating in the client PC 111.

The printer 110 is a multifunction peripheral having a plurality of functions such as a scanner and a printer, and is an example of an image processing apparatus.

Although the workflow system 10 of the present embodiment has the above-described services, the present invention is not limited thereto, and may have other configurations.

### <Hardware Configuration of Printer>

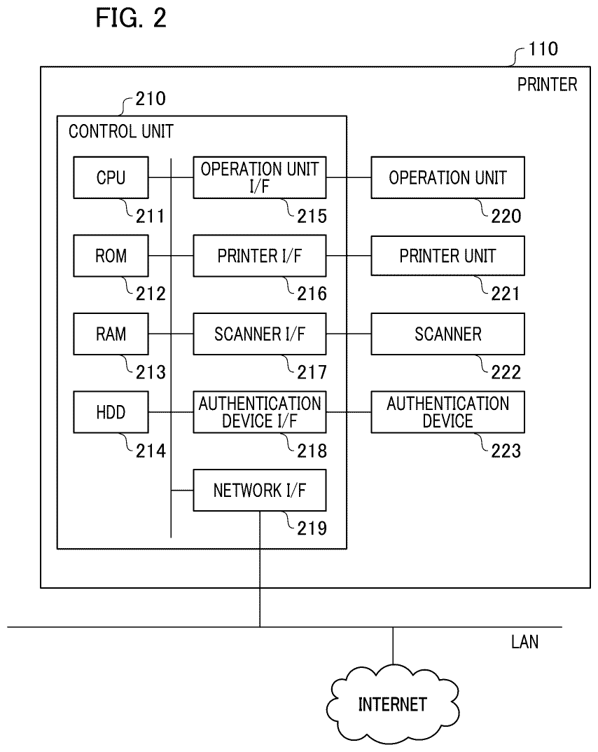

FIG. 2 is a hardware configuration diagram of the printer 110. The printer 110 has a control unit 210, an operation unit 220, a printer unit 221, a scanner unit 222, and an authentication device 223.

The control unit 210 controls the overall operation of the printer 110. The control unit 210 has a CPU 211, a ROM 212, a RAM 213, an HDD 214, an operation unit I/F 215, a printer I/F 216, a scanner I/F 217, an authentication device I/F 218, and a network I/F 219.

The CPU 211 realizes and controls various functions provided by the printer 110, such as reading/printing/communication, by reading out and executing programs stored in the ROM 212 or the HDD 214. The ROM 212 is a non-volatile memory and stores programs to be executed in the CPU 211 and data. The ROM is an abbreviation for “Read Only Memory”.

The RAM 213 is used as a temporary storage area such as a main memory or a work area of the CPU 211. The RAM is an abbreviation for “Random Access Memory”. The HDD 214 is a large-volume storage unit that stores programs to be executed in the CPU 211 and data.

The HDD is an abbreviation for “Hard Disk Drive”. Although, in the present embodiment, one CPU 211 uses one memory (RAM 213 or HDD 214) to execute each process as shown in a flowchart to be described below, the present invention is not limited thereto. For example, a plurality of CPUs or a plurality of RAMs or HDDs may cooperate with each other to execute each process.

The operation unit I/F 215 is an interface that connects the operation unit 220 and the control unit 210. The I/F is an abbreviation for “interface”. The operation unit 220 has a touch panel, a keyboard, and the like, and receives an operation, an input, and an instruction from a user.

The printer I/F 216 is an interface that connects the printer unit 221 and the control unit 210. Image data for printing is transferred from the control unit 210 to the printer unit 221 via the printer I/F 216, and is printed on a recording media.

The scanner I/F 217 is an interface that connects the scanner unit 222 and the control unit 210. The scanner unit 222 reads a document set on a document table and an ADF (not illustrated) to generate an image, and outputs the generated image data to the control unit 210 via the scanner I/F 217. The ADF is an abbreviation for “Auto Document Feeder”.

The printer 110 can print out (copy) the image data generated by the scanner unit 222 from the printer unit 221, and transmit the image data as a file or by e-mail.

The authentication device I/F 218 is an interface that connects the authentication device 223 and the control unit 210. The authentication device 223 is, for example, a card reader that reads an IC card, an fingerprint authentication device that reads a fingerprint, and the like, and is used for authentication for a user to use the printer 110.

The network I/F 219 is an interface that connects the control unit 210, that is, the printer 110, to LAN. The printer 110 transmits and receives various kinds of information such as image data and information to and from each service on the Internet using the network I/F 219.

### <Hardware Configuration of Client PC, Workflow Platform, and Print Service>

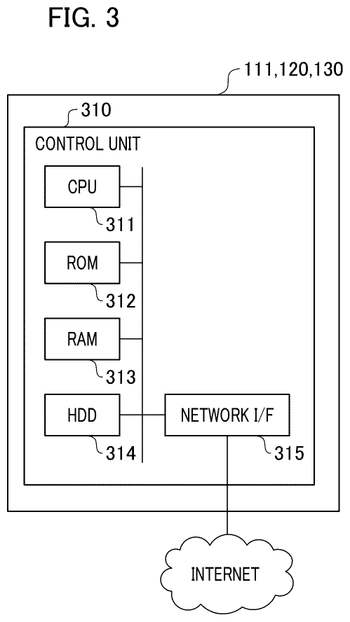

FIG. 3 is a hardware configuration diagram of each of the client PC 111, the print service 120, and the workflow platform 130.

Each of the client PC 111, the print service 120, and the workflow platform 130 has a control unit 310. The control unit 310 has a CPU 311, a ROM 312, a RAM 313, an HDD 314, and a network I/F 315.

The CPU 311 realizes various functions by reading out and executing programs stored in the ROM 312 or the HDD 314, and controls the entire operation. The ROM 312 is a non-volatile memory and stores programs to be executed in the CPU 311.

The RAM 313 is used as a temporary storage area such as a main memory or a work area of the CPU 311. The HDD 314 is a large-volume storage unit that stores programs to be executed in the CPU 311 and data. The network I/F 315 is an interface that connects each of the client PC 111, the print service 120, and the workflow platform 130 to the Internet.

The client PC 111, the print service 120, and the workflow platform 130 receive processing requests and transmit and receive various kinds of information to and from other apparatuses and services via the network I/F 315.

### <Software Configuration of Workflow System>

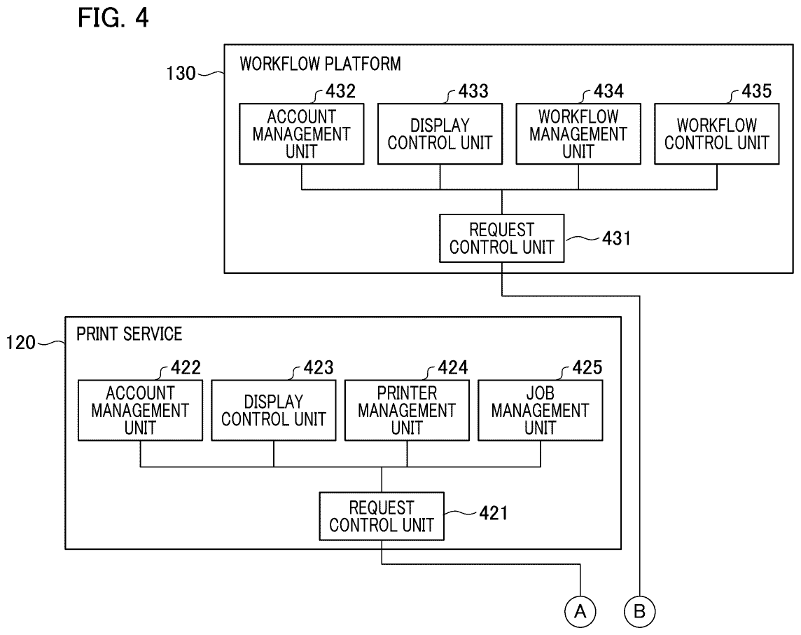

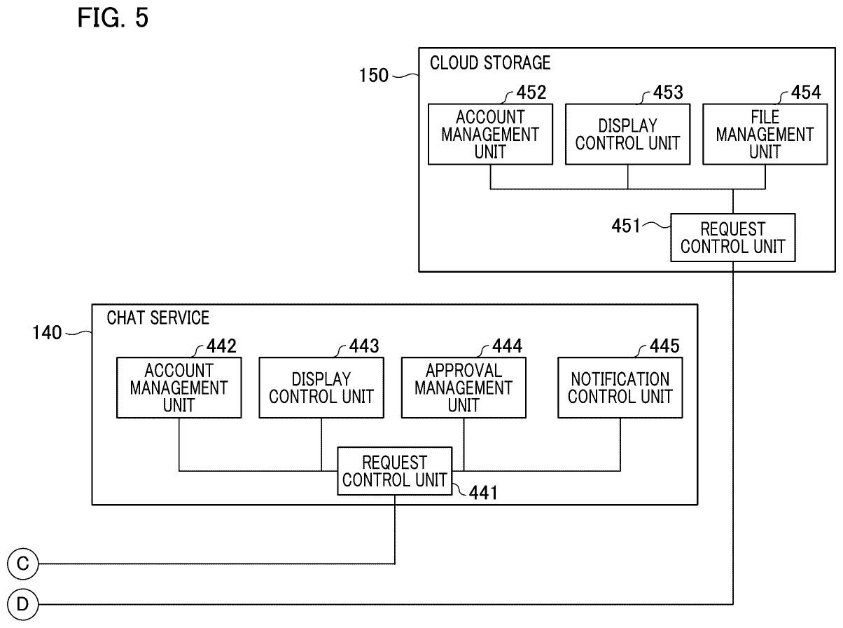

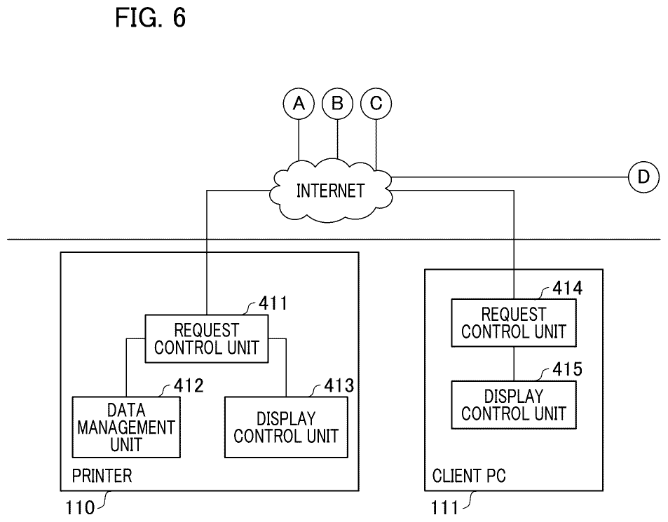

FIG. 4, FIG. 5, and FIG. 6 are software configuration diagrams of the workflow system 10 according to the present embodiment. The circled letters as shown in FIG. 4 are connected to the same letters in the circled letters as shown in FIG. 6. Additionally, the circled alphabetic character as shown in FIG. 5 is connected to the same circled alphabetic character as shown in FIG. 6.

As illustrated in FIG. 4, the workflow platform 130 has a request control unit 431, an account management unit 432, a display control unit 433, a workflow management unit 434, and a work flow control unit 435.

The request control unit 431 stands by in a state in which it can receive requests from the print service 120, the chat service 140, the cloud storage 150, the printer 110, and the client PC 111.

The account management unit 432 manages account information for logging in to the workflow platform 130. In the present embodiment, the workflow platform 130 and other services have different account information.

The present embodiment is not limited thereto, and an account management service shared by the each service may be separately prepared so that single sign-on can be performed on each service with the same account. For example, the accounts of the workflow platform 130 and the chat service 140 may be managed as the same account by the same account management unit.

The display control unit 433 receives a request from a web browser operating on the client PC 111 connected via the Internet and returns screen configuration information necessary for screen display. The screen configuration information is HTML, CSS, and the like.

HTML is an abbreviation for “HyperText Markup Language”. CSS is an abbreviation for “Cascading Style Sheets”. The display control unit 433 can also return the screen configuration information in response to a request from a web browser operating on another terminal apparatus, for example, a mobile terminal device.

The workflow management unit 434 creates a workflow in the workflow print service 120, and manages the workflow by editing and storing the workflow. The workflow control unit 435 controls execution and stop of a workflow stored in the workflow management unit 434 in response to a workflow execution request from the request control unit 431. This workflow execution process is an example of a workflow execution unit.

As illustrated in FIG. 4, the print service 120 has a request control unit 421, an account management unit 422, a display control unit 423, a printer management unit 424, and a job management unit 425. The request control unit 421 stands by in a state in which it can receive requests from the printer 110 and the workflow platform 130.

The account management unit 422 manages account information for logging in to the print service 120. Additionally, the account information for logging in to the print service 120 may be associated with the user information used for logging in to the printer 110.

The display control unit 423 receives a request from a web browser operating on the client PC 111 connected via the Internet, and returns screen configuration information necessary for screen display. The display control unit 423 can also return the screen configuration information in response to a request from a web browser operating on another apparatus such as an mobile device apparatus.

The printer management unit 424 manages a printer registered in the print service 424. The printer management unit 424 can also acquire the status, print performance, scan performance, and various settings of the registered printer.

The job management unit 425 receives and manages print and scan jobs from the workflow platform 130, the client PC 111, and the chat service 140. The job management unit 425 transmits a managed job to a printer registered in the print service 120 in response to a request, and causes the printer to execute the job.

As illustrated in FIG. 5, the chat service 140 has a request control unit 441, an account management unit 442, a display control unit 443, an approval management unit 444, and a notification control unit 445. The request control unit 441 waits in a state in which it can receive requests from the client PC 110, the print service 120, and the workflow platform 130.

The account management unit 442 manages account information for logging into the chat service 140. Additionally, as described in the explanation of the account management unit 432, the accounts of the workflow platform 130 and the chat service 140 may be managed as the same account by the same account management unit.

The display control unit 443 receives a request from a web browser operating on the client PC 111 connected via the Internet, and returns screen configuration information necessary for screen display. The display control unit 443 can also return the screen configuration information in response to a request from a web browser operating on another terminal apparatus, for example, a mobile device apparatus.

The approval management unit 444 receives an approval request from an external service, for example, the chat service 140, the workflow system 130, and the print service 120, and manages an approval request to an account on the chat service 140 and the approval status.

For example, the user of the chat service 140 can issue an approval request for an estimate on the chat service 140 to another user having an account on the chat service 140, and the account that has received the approval request can perform approval or denial processing.

The notification control unit 445 receives a notification request from an external service, for example, the chat service 140, the workflow system 130, and the print service 120, and performs notification to an account on the chat service 140.

As illustrated in FIG. 5, the cloud storage 150 has a request control unit 451, an account management unit 452, a display control unit 453, and a file management unit 454. The request control unit 451 waits in a state in which it can receive requests from the client PC 110, the print service 120, and the workflow platform 130.

The account management unit 452 manages account information for logging in to the cloud storage 150. Additionally, the accounts of the workflow platform 130 and the cloud storage 150 may be managed as the same account by the same account management unit.

The display control unit 453 receives a request from a web browser operating on the client PC 111 connected via the Internet, and returns screen configuration information necessary for screen display. The display control unit 453 can also return the screen configuration information in response to a request from a web browser operating on another terminal apparatus, for example, a mobile device apparatus.

The file management unit 454 manages files stored in the cloud storage 150, and stores, changes, deletes, and transmits the files in response to a request.

As shown in FIG. 6, the printer 110 has a request control unit 411, a data management unit 412, and a display control unit 413. The request control unit 411 stands by in a state in which it can receive a processing request from the print service 120. Upon receiving the processing request, the printer 110 appropriately instructs the display control unit 413 and the workflow management unit 434 to perform processing in response to the request.

A data management unit 412 manages user information, connection information with the print service 120, and the like. The display control unit 413 displays a UI screen for receiving a user operation on a liquid crystal display unit having a touch panel function of the operation unit 220 of the printer 110.

Note that although only one printer 110 connected to the print service 120 is illustrated in FIG. 4, FIG. 5, and FIG. 6, the workflow system 10 may have a plurality of printers connected to the print service 120.

Additionally, in a case where the printer 110 has been registered in the print service 120, the printer 101 communicates with the print service 120 constantly or periodically so that a request from the print service 120 can be received.

As illustrated in FIG. 6, the client PC 111 has a request control unit 414 and a display control unit 415. The client PC 111 accesses the print service 120, the workflow platform 130, the chat service 140, and the cloud storage 150 via the request control unit 414.

The user operates the workflow platform 130 and various online services via a screen displayed by a web browser displayed by the display control unit 415 of the client PC 111.

### <Flow of Processing>

First, a procedure for constructing a workflow on the workflow platform 130 will be explained. This procedure is an example of a workflow construction unit that constructs a workflow.

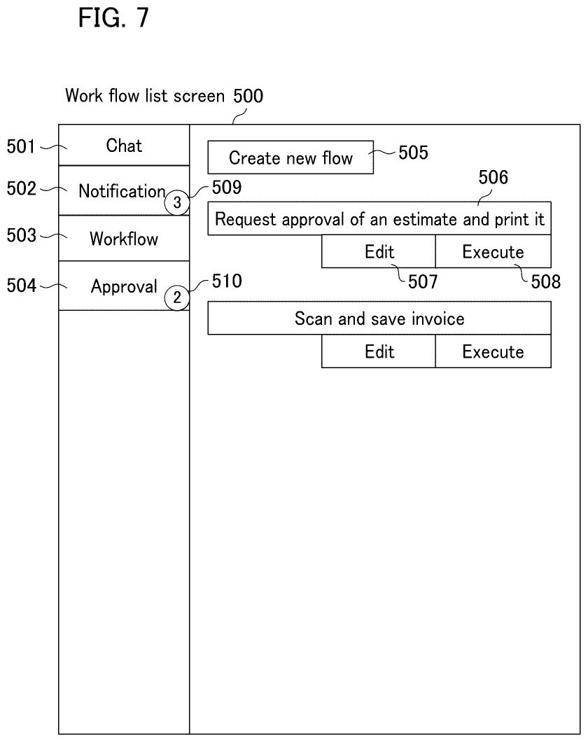

FIG. 7 is a diagram showing a workflow list screen displayed on the chat service in the system according to the first embodiment of the present invention. The chat service 140 cooperates with the workflow platform 130 by being authenticated by an account of the workflow platform 130.

The chat service 140 can display the workflow list screen 500 on the screen of the chat service 140 in cooperation with the workflow platform 130. Note that, as described above, the account of the chat service 140 may be the same account as that of the workflow platform 130, and in this case, authentication for cooperation is unnecessary.

The workflow list screen 500 is divided into two screens of a sidebar and a main screen. In the sidebar, the workflow list screen 500 displays a button 501 for transitioning to the chat screen, a button 502 for transitioning to the notification screen, a button 503 for transitioning to the workflow list screen, and a button 504 for transitioning to the approval screen.

The workflow list screen 500 displays, on the main screen, a button 505 for creating a new workflow, a field 506 for displaying the title of the created workflow, a button 507 for editing the workflow, and a button 508 for executing the workflow.

In a case where a transition is made from the workflow list screen 500 to the chat screen, the notification screen, or the approval screen, the display of the sidebar is not changed, and only the display of the main screen is changed. The workflow list screen 500 is displayed when the user presses the button 503. A workflow can be created, edited, or executed from the workflow list screen 500.

Note that depending on the workflow, the start condition of the workflow is created so as to be executed by, for example, a specific date and time or a specific action. In this case, when the button 508 is pressed, the content of a specific action serving as a condition can be manually set and executed.

A badge 509 is a badge indicating the number of unread notifications that have reached the chat service 140. In a case where the number of unread notifications is 0, the badge 509 is not displayed. A badge 510 is a badge indicating the number of unprocessed approval notifications that have reached the chat service 140. In a case where the number of unprocessed approval notifications is 0, the badge 510 is not displayed.

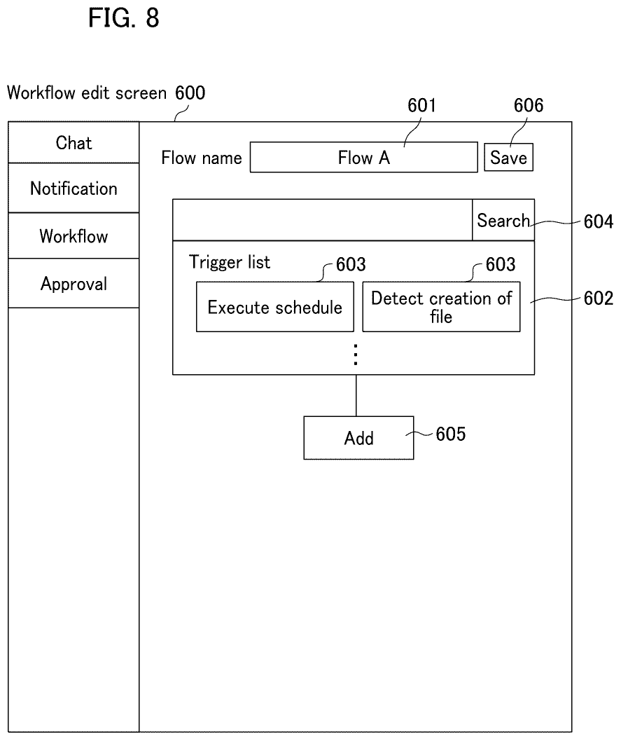

FIG. 8 is a view showing an example of a workflow edit screen 600 displayed when the button 505 for creating a new workflow is pressed. FIG. 8 is a diagram showing a screen for setting a workflow trigger displayed on the chat service in the system according to the first embodiment of the present invention. The workflow edit screen 600 is an example of a screen for setting a trigger of a workflow.

Similar to the workflow list screen 500, the workflow edit screen 600 is configured to be divided into two screens of a sidebar and a main screen. The main screen of the workflow edit screen 600 has a box 601 for editing a workflow name, a work flow trigger list screen 602, and a button 603 for selecting a trigger of a work flow.

The main screen of the workflow edit screen 600 has a button 604 for searching for a trigger of the workflow, a button 605 for adding an action to the workflow, and a button 606 for saving the workflow.

A workflow in the workflow platform 130 is constructed by combining a trigger that is an execution condition of the workflow and an action that is a processing content of the workflow. Since the start of a workflow must always be a trigger, a trigger is set before an action on the workflow edit screen 600.

The workflow trigger list screen 602 displays the usable triggers of the workflow platform 130 in a list. The trigger is, for example, a schedule trigger that periodically starts a workflow, a file trigger that is executed when arbitrary cloud storage is updated, and a scan trigger that is executed when a printer starts scanning.

These are merely examples, and actions provided by the workflow platform 130 and other external services are not limited to these examples.

When the button 603 is pressed, if the external service that provides the trigger and the account logged in to the workflow platform 130 have already cooperated, a trigger setting screen is displayed. In a case where cooperation has not been completed, an authentication screen for performing cooperation is displayed, and a trigger setting screen is displayed after the authentication.

The button 604 is used to search for a work flow trigger displayed on the work flow trigger list screen 602, and a trigger can be searched for with an input character string. A trigger of the workflow platform 130 itself, a trigger of another external service, and a trigger of a print service are search targets.

For example, when a search is performed by inputting a character string “save”, a list of triggers related to saving, such as an action triggered by data being saved in the cloud storage 150, is displayed. Similarly, by searching for “scan”, a list of triggers for starting a workflow when the print service 120 performs scanning is displayed.

When the user selects an action to be used in the workflow from the search result, a trigger for starting execution of the workflow is determined.

When the button 605 is pressed, a workflow action addition screen is displayed. When the button 606 is pressed, the created workflow is saved.

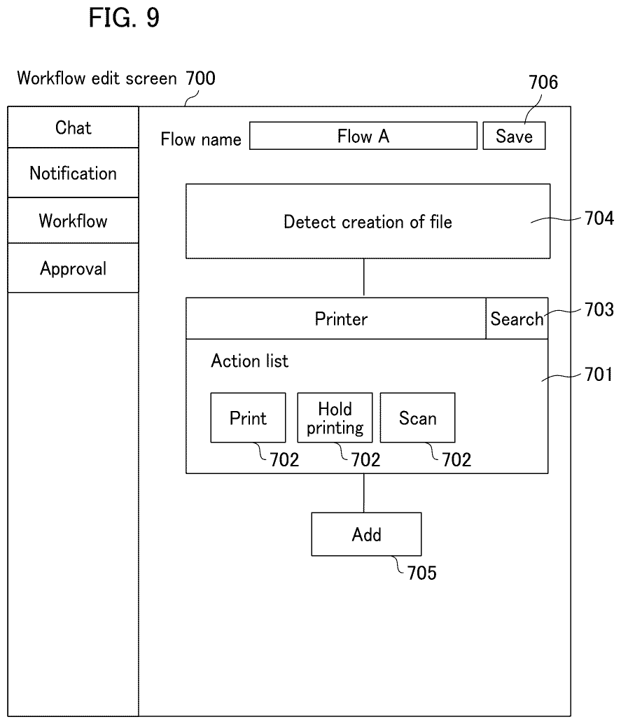

FIG. 9 is a view showing an example of a workflow edit window 700 displayed when the button 605 is pressed. FIG. 9 is a view showing a screen for setting an action of a workflow displayed on the chat service in the system according to the first embodiment of the present invention.

The workflow action corresponds to one process of the workflow, and performs some transmission or reception to or from an external service, or performs control processing of the workflow itself such as standby, branching, or repetition of the workflow.

The main screen of the workflow edit screen 700 has a workflow action list screen 701, a button 702 for selecting an action of a workflow, and a button 703 for searching for an action of a workflow.

The main screen of the workflow edit screen 700 has a button 704 that displays a set trigger name and displays a trigger edit screen when pressed. The main screen of the workflow edit screen 700 has a button 705 for adding an action of the workflow and a button 706 for saving the workflow.

The workflow action list screen 701 displays the usable actions of the workflow platform 130 in a list. The action is, for example, a print action for starting printing by the printer, a hold printing action for performing hold printing by the printer, and a scan action for starting scanning by the printer.

These are merely examples, and the action need not be related to the printer, and for example, the action also includes an approval request, a notification request, saving of a file, conditional branch, and repetitive processing. Additionally, the actions provided by the workflow platform 130 and other external services are not limited to these examples.

When the button 702 is pressed, an action setting screen is displayed if the account logging in the workflow platform 130 has already cooperated with the external service providing the action. When the cooperation is not completed, an authentication screen for performing the cooperation is displayed, and an action setting screen is displayed after the authentication.

The button 703 is used to search for a workflow action displayed on the workflow action screen 701, and an action can be searched for using an input character string. Actions of the workflow platform 130 itself, actions of other external services, and actions of the print service 120 are search targets.

For example, when a search is performed by inputting a character string “notify”, an action for the chat service 140 to notify an arbitrary user or group and the like is displayed. Alternatively, when a search is performed by inputting a character string “save”, a list of actions related to saving, such as saving data in the cloud storage 150, is displayed.

Similarly, by searching for “print”, a list of actions of connectors for which the print service 120 performs printing is displayed. The user selects an action to be used in the workflow from the search result, thereby determining the action of the workflow.

The button 704 displays a set trigger name. When the button 704 is pressed, a trigger edit screen is displayed.

When the button 705 is pressed, a new workflow action list screen 701 is displayed below the already displayed workflow action list screen 701. This makes it possible to create a workflow by combining a plurality of workflow actions. When the button 706 is pressed, the created workflow is saved.

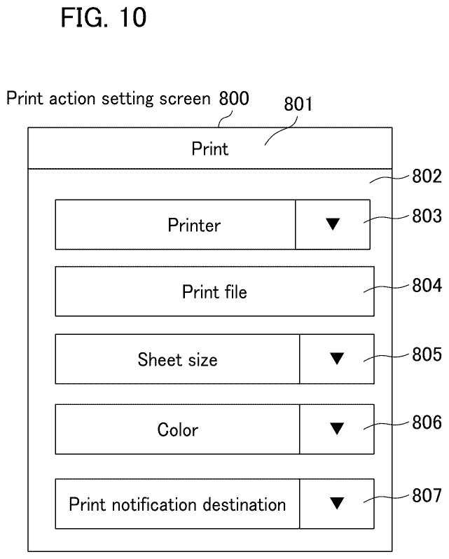

FIG. 10 shows a screen for setting a workflow action and a workflow trigger. FIG. 10 is a diagram showing a screen for setting details of a trigger or an action of a workflow displayed on a chat service in the system according to the first embodiment of the present invention. Here, a workflow action setting screen 800 that performs printing is shown as an example.

The workflow action setting screen 800 has a field 801 for displaying an action name and an action setting list 802. The action setting list 802 has action settings 803, 804, 805, 806, and 807.

The action settings 803, 804, 805, 806, and 807 are examples of print action settings. In this action setting, input by a method such as free character string input, selection from options, and use of values acquired in preceding and subsequent workflows is received.

Additionally, the candidates of the options in the action setting can be acquired from an external service and displayed. Additionally, what is related to these settings is applied to the case of trigger settings in addition to action settings.

The field 801 displays the name of the action. Additionally, the name displayed in the field 801 may be freely changed by the user. The workflow action setting screen 800 sets a workflow action having the action name in the field 801 according to the contents designated by each action setting in the action setting list 802.

The action setting 803 receives designation of a printer that performs printing. When the action setting 803 is pressed, options are displayed, and when the user selects one of the options, a printer is designated. The selectable printers are printers registered in the print service 120.

The action setting 804 receives designation of a target file to be printed. As the designation method here, a file acquired by the workflow trigger or the workflow action executed prior to the print action, a URL indicating the file, and the like are designated. For example, a file acquired from the cloud storage 150 is designated. URL is an abbreviation for “Uniform Resource Locator”.

The action setting 805 receives designation of a sheet size. The action setting 806 receives designation of a color setting of printing. When the action settings 805 and 806 are pressed, options are displayed, and the user selects the options to designate the action settings. These are examples of the print settings, and more detailed print settings may be designated.

The print settings depend on the performance of the printer used for printing. Therefore, as options of the action settings 805 and 806, after the printer is designated in the action setting 803, print settings that can be selected are received from the print service 120 and displayed as options.

Additionally, for such a print setting, a value acquired by a work flow trigger or a workflow action executed prior to the print action may be used. Additionally, in a case where the settings conflict with each other, the display may be grayed out or invalidated so that the setting items that cannot be selected at the same time.

The action setting 807 receives designation of presence or absence of a notification regarding printing, notification contents, and a notification destination. The action setting 807 is pressed to display options, and the user selects one of the options to designate the action.

As the notification destination, an account or a group of the workflow platform 130 or an arbitrary account or group of the chat service 140 or the print service 120 in cooperation can be selected.

Additionally, the workflow platform 130 or the print service 120 may determine a notification destination according to the error content and provide a notification. Examples of the notification destination in this case include a user who has executed the workflow, a user who has executed printing, and a user who performs a post-process operation on the workflow.

Note that although notification is set as the setting of a workflow action that performs printing, a workflow may be constructed so as to acquire the result of a print action and perform notification as another action of the workflow platform 130.

Additionally, only a specific notification among various notification types may be included in the print action. For example, the print success notification may define the workflow as another notification action of the workflow platform 130, and the print failure notification may be provided by the print action itself so that it is not necessary to separately incorporate the notification action.

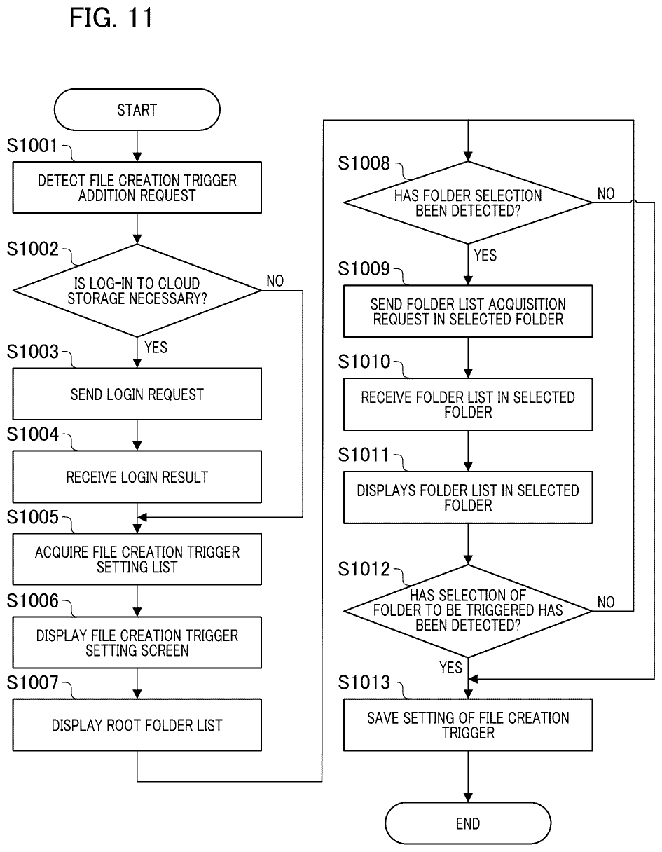

Next, a procedure for actually connecting to and setting each service in order to construct a workflow will be explained with reference to flowcharts. FIG. 11 is a flowchart showing the details of constructing a workflow in cooperation with the cloud storage 150 in the workflow platform 130 in the present system.

FIG. 11 is a flowchart showing file trigger setting processing according to the first embodiment of the present invention. In the present embodiment, as an example, a file creation trigger that executes a workflow during file creation is constructed as a workflow trigger.

In step S1001, the workflow platform 130 detects a file creation trigger addition request.

In step S1002, the workflow platform 130 confirms whether or not cooperation with the cloud storage 150 that provides a file creation trigger has been set, and determines whether or not log in to the cloud storage 150 is necessary.

In a case where the workflow platform 130 determines that a login to the cloud storage 150 is necessary, the process of step S1003 is executed. In a case where the workflow platform 130 determines that it is not necessary to log in to the cloud storage 150, the process of step S1005 is executed.

In step S1003, the workflow platform 130 transmits a login request to the cloud storage 150.

In step S1004, the workflow platform 130 receives the login result from the cloud storage 150. Thereafter, the workflow platform 130 can communicate with the cloud storage 150 in cooperation with the cloud storage 150.

In step S1005, the workflow platform 130 acquires a setting list of file creation triggers.

In step S1006, the workflow platform 130 displays the setting list of the file creation trigger acquired in step S1005. Note that as the options of the respective settings, options acquired from an external service, here, the cloud storage 150 that cooperates, can be displayed.

In the file creation trigger, it is necessary to set in which file the trigger that the file has created is executed. In step S1007, the workflow platform 130 first displays a root folder list of the cloud storage 150.

In step S1008, the workflow platform 130 determines whether or not it has detected that an arbitrary folder has been selected from the list. In a case where the workflow platform 130 determines that a folder selection has been detected, the process of step S1009 is executed. In a case where the workflow platform 130 determines that the folder selection has not been detected, the process of step S1013 is executed.

In step S1009, the workflow platform 130 transmits a folder list acquisition request in the selected folder.

In step S1010, the workflow platform 130 receives the folder list acquisition result.

In step S1011, the workflow platform 130 displays the folder list received in step S1010.

In step S1012, the workflow platform 130 determines whether or not selection of a folder to be triggered has been detected. In a case where the workflow platform 130 determines that the selection of a folder to be triggered has been detected, the process of step S1013 is executed. In a case where the workflow platform 130 determines that selection of a folder to be triggered has not been detected, the process of step S1008 is executed.

In step S1013, the workflow platform 130 saves the settings of the file creation trigger.

By the procedure of FIG. 11, the workflow platform 130 can incorporate the file creation trigger into an arbitrary workflow. Note that the file creation trigger provides acquisition of metadata related to a file such as a name, an ID, a time, and a folder path of the created file in a workflow action to be executed later.

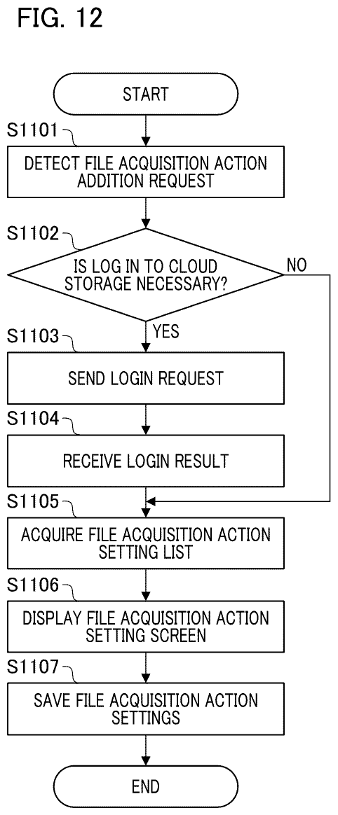

FIG. 12 is a flowchart showing details of the workflow construction in cooperation with the cloud storage 150 in the workflow platform 130 in the present system. FIG. 12 is a flowchart showing processing of setting a file acquisition action according to the first embodiment of the present invention.

In the present embodiment, as an example, a file acquisition action that acquires a file of the cloud storage 150 is constructed as an action of the workflow. The file acquisition action is an action that acquires the content of a designated file, a published URL, or a limitedly published URL.

In step S1101, the workflow platform 130 detects a file acquisition action addition request.

In step S1102, the workflow platform 130 confirms whether or not cooperation with the cloud storage 150 that provides a file acquisition action has been set, and determines whether or not login to the cloud storage 150 is necessary.

In a case where the workflow platform 130 determines that a login to the cloud storage 150 is necessary, the process of step S1103 is executed. In a case where the workflow platform 130 determines that it is not necessary to log in to the cloud storage 150, the process of step S1105 is executed. For example, in a case where the processes of the flowchart as illustrated in FIG. 11 has already been executed, the login is not necessary because the cooperation has been completed.

In step S1103, the workflow platform 130 transmits a login request to the cloud storage 150.

In step S1104, the workflow platform 130 receives the login result from the cloud storage 150. Thereafter, the workflow platform 130 can communicate with the cloud storage 150 in cooperation with the cloud storage 150.

In step S1105, the workflow platform 130 acquires a setting list of the file acquiring action.

In step S1106, the workflow platform 130 displays a setting screen for the file acquisition action acquired in step S1105. In the file acquisition action, it is necessary to set a file to be acquired.

For example, a workflow is constructed so that a target file to be acquired can be identified from file path that can be acquired as a result of execution of the file creation trigger in FIG. 11 and values that can be acquired from other triggers and actions.

In step S1107, the workflow platform 130 saves the setting of the set file acquisition action.

By the procedure of FIG. 12, the workflow platform 130 can incorporate the file acquisition action into an arbitrary workflow.

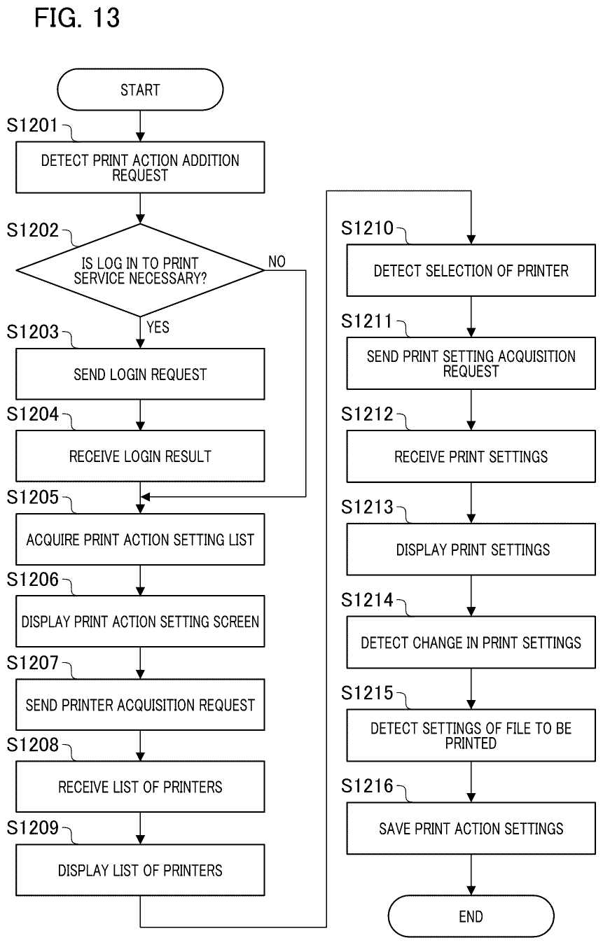

FIG. 13 is a flowchart showing the details of constructing a workflow in cooperation with the print service 120 in the workflow platform 130 in the present system. FIG. 13 is a flowchart of a workflow platform showing a print action according to the first embodiment of the present invention.

In the present embodiment, as an example, an action for printing a file by a printer designated by the print service 120 is constructed as an action of a workflow.

In step S1201, the workflow platform 130 detects a print action addition request.

In step S1202, the workflow platform 130 confirms whether or not cooperation with the print service 120 that provides a print action has been set, and determines whether or not login to the print service 120 is necessary.

In a case where the workflow platform 130 determines that it is necessary to log in to the print service 120, the process of step S1203 is executed. In a case where the workflow platform 130 determines that it is not necessary to log in to the print service 120, the process of step S1205 is executed.

In step S1203, the workflow platform 130 transmits a login request to the print service 120.

In step S1204, the workflow platform 130 receives the login result from the print service 120. After that, the workflow platform 130 can communicate with the print service 120 in cooperation with the print service 120.

In step S1205, the workflow platform 130 acquires a print action setting list.

In step S1206, the workflow platform 130 displays the print action setting screen acquired in step S1205. In the print action, for example, as shown in FIG. 10, settings for specifying a printer to perform printing, print settings, and specifying a file to be printed are displayed.

In step S1207, the workflow platform 130 transmits a printer acquisition request to the print service 120.

In step S1208, the workflow platform 130 acquires a list of printers from the print service 120.

In step S1209, the workflow platform 130 displays the list of printers acquired in step S1208.

In step S1210, the workflow platform 130 detects that the user has selected a printer.

In step S1211, the workflow platform 130 transmits a print setting acquisition request to the print service 120. At this time, the print setting acquisition request transmitted in step S1211 includes information for specifying the printer.

In step S1212, the workflow platform 130 receives the print settings from the print service 120.

In step S1213, the workflow platform 130 displays the print settings that have been received in step S1212.

In step S1214, the workflow platform 130 detects a change in the print settings by the user.

In step S1215, the workflow platform 130 detects a change in file settings to be printed by the user.

In step S1216, the workflow platform 130 saves the settings of the print action.

According to the procedure of FIG. 13, the workflow platform 130 can incorporate a print action for performing printing into an arbitrary workflow in cooperation with the print service 120.

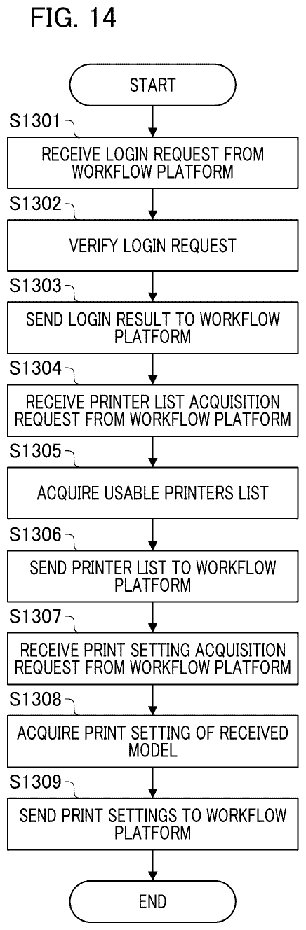

FIG. 14 is a flowchart showing the details of constructing a workflow in cooperation with the print service 120 in the workflow platform 130 in the present system. FIG. 14 is a flowchart of a print service showing a print action according to the first embodiment of the present invention.

In step S1301, the print service 120 receives a login request from the workflow platform 130.

In step S1302, the print service 120 verifies the login request.

In step S1303, the print service 120 transmits the login result to the workflow platform 130. As a result, the workflow platform 130 and the print service 120 are in a coordinated state, and can communicate with each other thereafter.

In step S1304, the print service 120 receives a printer list acquisition request from the workflow platform 130.

In step S1305, the print service 120 acquires a list of printers usable in the workflow platform 130 from the printers managed by the print service 120. Regarding the usable printer at this time, for example, the administrator of the print service 120 may be able to restrict, for each printer, whether or not the printer of the account of the print service 120 logged in in step S1301 to step S1303 is usable.

In step S1306, the print service 120 transmits the list of printers acquired in step S1305 to the workflow platform 130.

In step S1307, the print service 120 receives a print setting acquisition request from the workflow platform 130. At this time, the print setting acquisition request received in step S1307 includes information for specifying the printer.

In step S1308, the print service 120 specifies a target printer based on the information for specifying the printer, and acquires print settings of the printer model. At this time, the administrator of the print service 120 may be able to restrict each setting of the settable setting items in association with the account of the print service 120 logged into in steps S1301 to S1303.

For example, even if the designated printer can perform single-sided printing, only double-sided printing is transmitted as the print setting if the administrator limits the printing to only double-sided printing.

In step S1309, the print service 120 transmits the acquired print settings to the workflow platform 130.

According to the procedure of FIG. 14, the print service 120 can set a print action for performing printing in cooperation with the workflow platform 130.

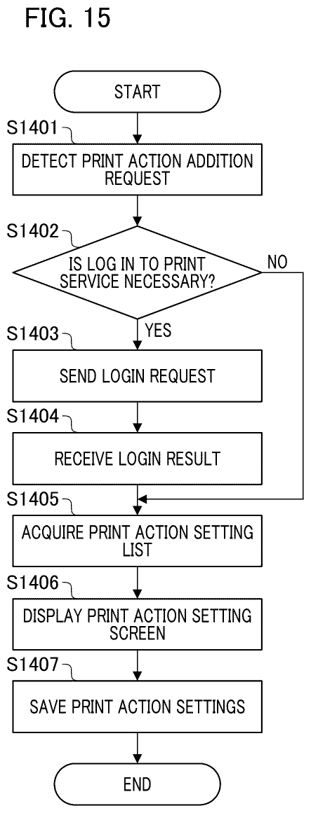

FIG. 15 is a flowchart showing the details of constructing a workflow in cooperation with the print service 120 in the workflow platform 130 in the present system. FIG. 15 is a flowchart of a workflow platform showing a hold printing action according to the first embodiment of the present invention.

In the present embodiment, as an example, an action to hold and print a file by an arbitrary printer managed by the print service 120 is constructed as an action of a workflow.

In step S1401, the workflow platform 130 detects a print action addition request.

In step S1402, the workflow platform 130 confirms whether or not cooperation with the print service 120 that provides a print action has been set, and determines whether or not login to the print service 120 is necessary.

In a case where the workflow platform 130 determines that it is necessary to log in to the print service 120, the process of step S1403 is executed. In a case where the workflow platform 130 determines that it is not necessary to log in to the print service 120, the process of step S1405 is executed.

In step S1403, the workflow platform 130 transmits a login request to the print service 140.

In step S1404, the workflow platform 130 receives the login result from the print service 140. After that, the workflow platform 130 can communicate with the print service 120 in cooperation with the print service 120.

In step S1405, the workflow platform 130 acquires a print action setting list.

In step S1406, the workflow platform 130 displays the print action setting screen acquired in step S1405. In the hold printing action, the setting items are different from those of the printing as shown in FIG. 14. For example, if hold printing can be performed from an arbitrary printer, designation of a printer is not necessary.

Additionally, in the case of hold printing, the print settings can be set on the screen of the printer before printing, and thus are not necessary. Alternatively, as a setting that can be changed on the printer screen but is performed by default, the print setting may be enabled on the workflow platform 130 as in FIG. 14.

In step S1407, the workflow platform 130 saves the settings of the print action.

According to the procedure of FIG. 15, the workflow platform 130 can incorporate a hold printing action that performs hold printing into an arbitrary workflow in cooperation with the print service 120.

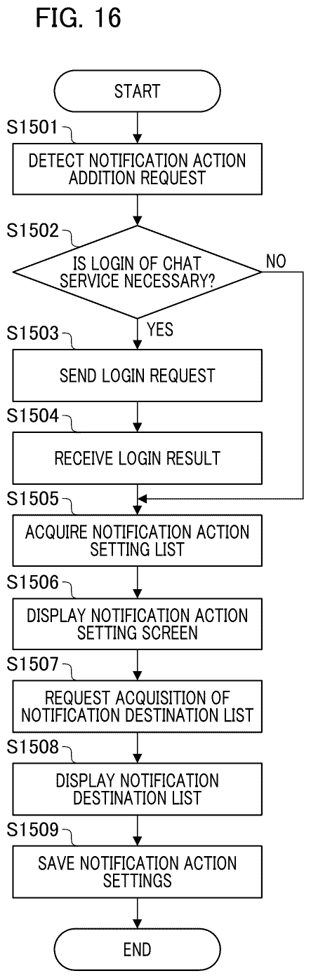

FIG. 16 is a flowchart showing the details of constructing a workflow in cooperation with the chat service 140 in the workflow platform 130 in the present system. FIG. 16 is a flowchart of a workflow platform showing a notification action according to the first embodiment of the present invention.

In the present embodiment, as an example, an action of performing notification to a notification destination designated by the chat service 140 is constructed as an action of a workflow.

In step S1501, the workflow platform 130 detects a notification action addition request.

In step S1502, the workflow platform 130 confirms whether or not cooperation with the chat service 140 that provides a notification action has been set, and determines whether or not login to the chat service 140 is necessary.

In a case where the workflow platform 130 determines that a login to the chat service 140 is necessary, the process of step S1503 is executed. In a case where the workflow platform 130 determines that it is not necessary to log in to the chat service 140, the process of step S1505 is executed.

In step S1503, the workflow platform 130 transmits a login request to the chat service 140.

In step S1504, the workflow platform 130 receives the login result from the chat service 140. Thereafter, the workflow platform 130 can communicate with the chat service 140 in cooperation with the chat service 140.

Note that, as described above, the account of the chat service 140 may be the same account as that of the workflow platform 130, and in this case, login for cooperation is unnecessary.

In step S1505, the workflow platform 150 acquires a notification action setting list

In step S1506, the workflow platform 150 displays the setting screen of the notification action acquired in step S1505.

In step S1507, the workflow platform 130 transmits a notification destination list acquisition request to the chat service 140.

In step S1508, the workflow platform 130 receives a list of notification destinations from the chat service 140. The setting of the notification action includes designation of a user or a group channel of the chat service 140 of the notification destination, a type of notification, a message content of the notification, a response time limit of the notification, and the like. These are examples, and items other than these may be included even if these are not included.

The type of the notification includes a printable notification, a print completion notification, a print error notification, and an approval request notification, in addition to a general message notification. Additionally, the approval request notification temporarily stops the workflow processing of the workflow platform 130 until approval is permitted.

Additionally, in addition to an approval request destination, the approval request notification can designate an approval request completion notification destination to be notified when the approval request is completed. In a case where the approval request completion notification destination is not designated, the notification destination is the user who has executed the workflow.

In step S1509, the workflow platform 130 saves the notification action settings.

According to the procedure of FIG. 16, the workflow platform 130 cooperates with the chat service 140, and can incorporate an action of performing a notification from the chat service 140 into an arbitrary workflow.

Next, a flowchart for executing the workflow configured by the procedure as explained in FIG. 11 to FIG. 16 will be explained. In the present embodiment, an operation during execution of a workflow in which an estimate is approved, the approved estimate is automatically printed, and a notification of a print result is performed will be described.

Note that this embodiment is merely an example, and the services to be combined and the order thereof are not limited thereto. Although, for example, in the present embodiment, the workflow starts with the storage of a file in the cloud storage 150 as a trigger, the present invention is not limited thereto.

For example, the workflow may be triggered by scanning performed by the printer 110. Additionally, a list of constructed workflows of the workflow platform 130 may be displayed on the chat service 140 so that a workflow selected from the chat service 140 can be executed.

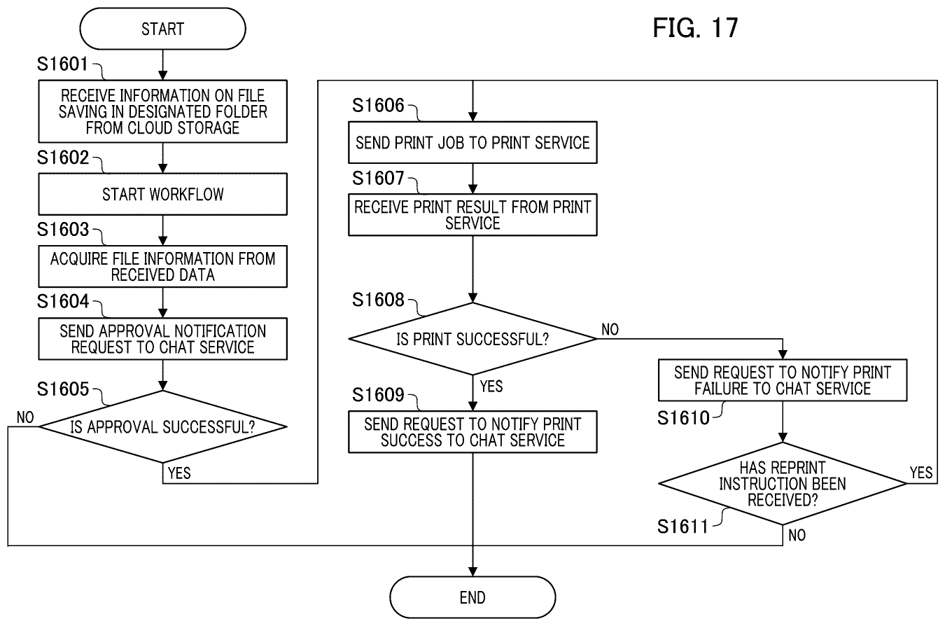

FIG. 17 is a flowchart showing the operation when the workflow is executed in the workflow platform 130 in the present system. FIG. 17 is a flowchart of a workflow platform when a workflow is executed according to the first embodiment of the present invention.

In step S1601, the workflow platform 130 receives information indicating that the file has been saved in the designated folder from the cloud storage 150. The file is, for example, a document file of an estimate.

In step S1602, the workflow platform 130 receives the notification and starts the corresponding workflow.

In step S1603, the workflow platform 130 acquires file information from the file received in step S1601. The file information acquired here is information necessary for the print service 120 to print the file, such as the contents of the file itself or a URL and a file name from which the file can be downloaded.

In step S1604, the workflow platform 130 transmits an approval notification request to the chat service 140. This approval notification request includes the notification destination set in advance in the flowchart of FIG. 16, and the notification destination information after approval.

In step S1605, the workflow platform 130 receives a notification about whether or not the result of the approval request is a success or a denial from the chat service 140, and determines the result. In a case where the workflow platform 130 determines that the result of the approval request is an approval success, the process of step S1606 is executed. In a case where the workflow platform 130 determines that the result of the approval request is not an approval success, the process ends.

In step S1606, the workflow platform 130 transmits the print job to the print service 120. At this time, the file acquired in step S1603 is transmitted. Additionally, at this time, the printing may be either normal printing as shown in FIG. 15 or hold printing as shown in FIG. 16.

In step S1607, the workflow platform 130 receives a print result from the print service 120.

In step S1608, the workflow platform 130 determines whether or not the print result received in step S1607 is successful. In a case where the workflow platform 130 determines that the printing is successful, the process of step S1609 is executed. In a case where the workflow platform 130 determines that the printing is not successful, the process of step S1610 is executed.

In step S1609, the workflow platform 130 transmits a print success notification request to the chat service 140, and process ends. The print success notification request includes the notification destination information set in advance in the flowchart of FIG. 16.

In step S1610, the workflow platform 130 transmits a print failure notification request to the chat service 140. This print failure notification request includes the notification destination information set in advance in the flowchart of FIG. 16.

Note that although, in the present embodiment, the workflow platform 130 performs the determination of the success or failure of printing and the notification through the chat service 140, the print service 120 may perform similar notification processing instead of the workflow platform 130. At this time, the destination of the notification is, for example, a user who has started the workflow, a user who has executed printing included in the workflow, or a plurality of users including these users.

In step S1611, the workflow platform 130 determines whether or not reprint instruction has been received from the print service 120. In a case where the workflow platform 130 determines that a reprint instruction has been received, the process of step S1606 is executed. In a case where the workflow platform 130 determines that a reprint instruction has not been received, the process ends.

By the procedure of FIG. 17, the workflow platform 130 can execute a workflow in cooperation with the print service 120, the cloud storage 150, and the chat service 140 to print a file.

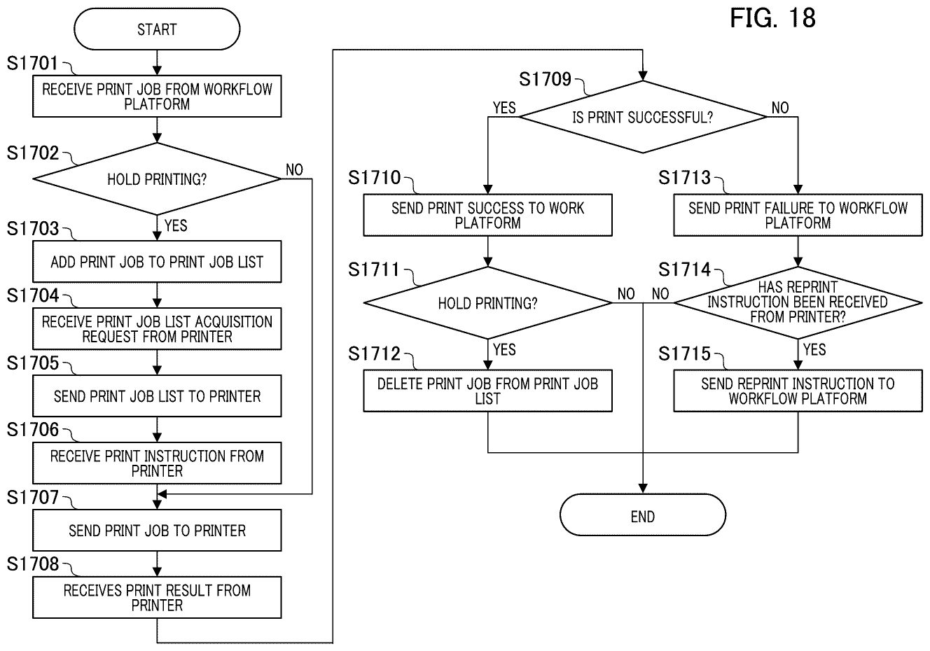

FIG. 18 is a flowchart showing the operation when a workflow is executed in the workflow platform 130 in the present system. FIG. 18 is a flowchart of the print service when the workflow is executed according to the first embodiment of the present invention.

In step S1701, the print service 120 receives a print job from the workflow platform 130.

In step S1702, the print service 120 determines whether or not the received job is hold printing. In a case where the print service 120 determines that the received job is hold printing, the process of step S1703 is executed. In a case where the print service 120 determines that the received job is not hold printing, the process of step S1707 is executed.

In step S1703, the print service 120 adds the received print job to the print job list.

In step S1704, the print service 120 receives a print job list acquisition request from the printer 110.

In step S1705, the print service 120 transmits the print job list to the printer 110. The print job list includes a print job identifier that identifies a print job.

In step S1706, the print service 120 receives a print instruction from the printer 110. The print instruction includes a print job identifier that identifies the print job.

In step S1707, the print service 120 specifies a print job to be transmitted from the print job identifier, and transmits the print job to the printer 110.

In step S1708, the print service 120 receives a print result from the printer 110.

In step S1709, the print service 120 determines whether or not the printing is successful. In a case where the print service 120 determines that the printing is successful, the process of step S1710 is executed. In a case where the print service 120 determines that the printing is not successful, the process of step S1713 is executed.

In step S1710, the print service 120 transmits a print success to the workflow platform 130.

In step S1711, the print service 120 determines whether or not the successfully printed job is hold printing. In a case where the print service 120 determines that the successfully printed job is hold printing, the process of step S1712 is executed. In a case where the print service 120 determines that the successfully printed job is not hold printing, the process ends.

In step S1712, the print service 120 deletes the successfully printed print job from the print job list, and the process ends.

In step S1713, the print service 120 transmits a print failure to the workflow platform 130. If printing has failed, reprinting is enabled.

In step S1714, the print service 120 determines whether or not a reprint instruction has been received from the printer 110. In a case where the print service 120 determines that a reprint instruction has been received, the process of step S1715 is executed. In a case where the print service 120 determines that a reprint instruction has not been received, the process ends.

In step S1715, the print service 120 transmits a reprint instruction to the workflow platform 130, and the process ends.

According to the procedure of FIG. 18, the print service 120 can execute a workflow in cooperation with the printer 110 and the workflow platform 130 to print a file.

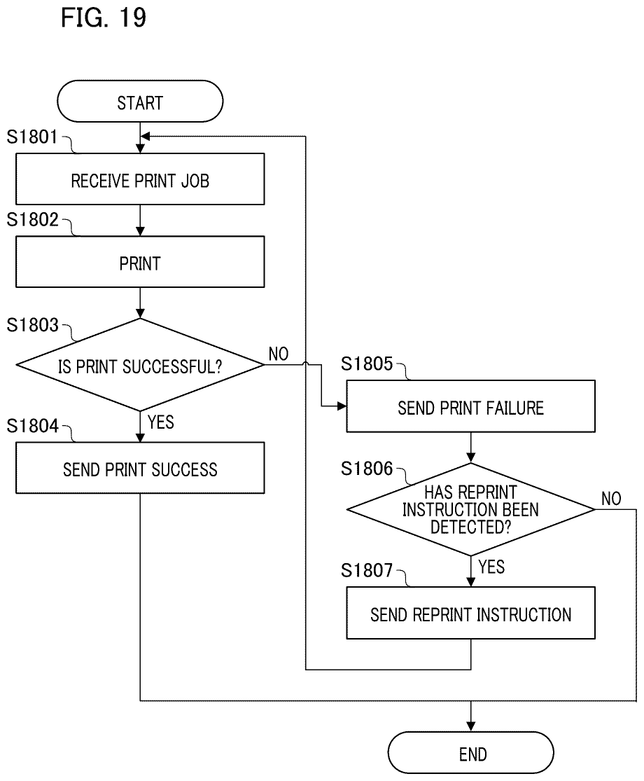

FIG. 19 is a flowchart showing print processing when a workflow in this system is executed. FIG. 19 is a flowchart of printing performed by the printer during execution of the workflow according to the first embodiment of the present invention.

In step S1801, the printer 110 receives a print job from the print service 120.

In step S1802, the printer 110 executes the received print job and prints it.

In step S1803, the printer 110 determines whether or not the printing is successful. In a case where the printer 110 determines that the printing is successful, the process of step S1804 is executed. In a case where the printer 110 determines that the printing is not successful, the process of step S1805 is executed.

In step S1804, the printer 110 transmits a print success notification to the print service 120, and the process ends.

In step S1805, the printer 110 transmits a print failure to the print service 120.

In step S1806, the printer 110 waits for a reprint instruction from the user, and determines whether or not the reprint instruction has been detected. In a case where the printer 110 determines that a reprint instruction has been detected, the process of step S1807 is executed. In a case where the printer 110 determines that a reprint instruction has not been detected, the process ends.

In step S1807, the printer 110 transmits a reprint instruction to the print service 120. Thereafter, the process is executed again from step S1801.

According to the procedure of FIG. 19, the printer 110 can print a file in cooperation with the print service 120.

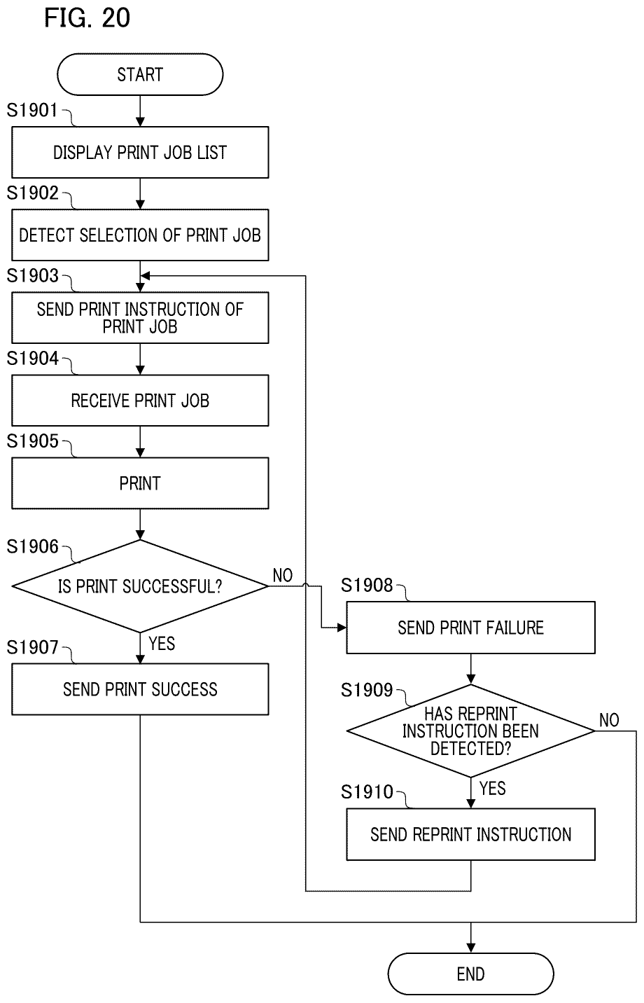

FIG. 20 is a flowchart showing hold printing processing when a workflow in the present system is executed. FIG. 20 is a flowchart of hold printing performed by the printer when the workflow is executed according to the first embodiment of the present invention.

In step S1901, the printer 110 displays a print job list.

In step S1902, the printer 110 detects selection of a print job by the user. At this time, the print setting may be performed on the UI of the printer 110.

In step S1903, the printer 110 transmits a print instruction of the detected print job. The subsequent processes of step S1904 to step S1910 are similar to the processes of step S1801 to step S1807 as described above, and thus the explanation thereof will be omitted here.

According to the procedure of FIG. 20, the printer 110 can hold and print a file in cooperation with the print service 120.

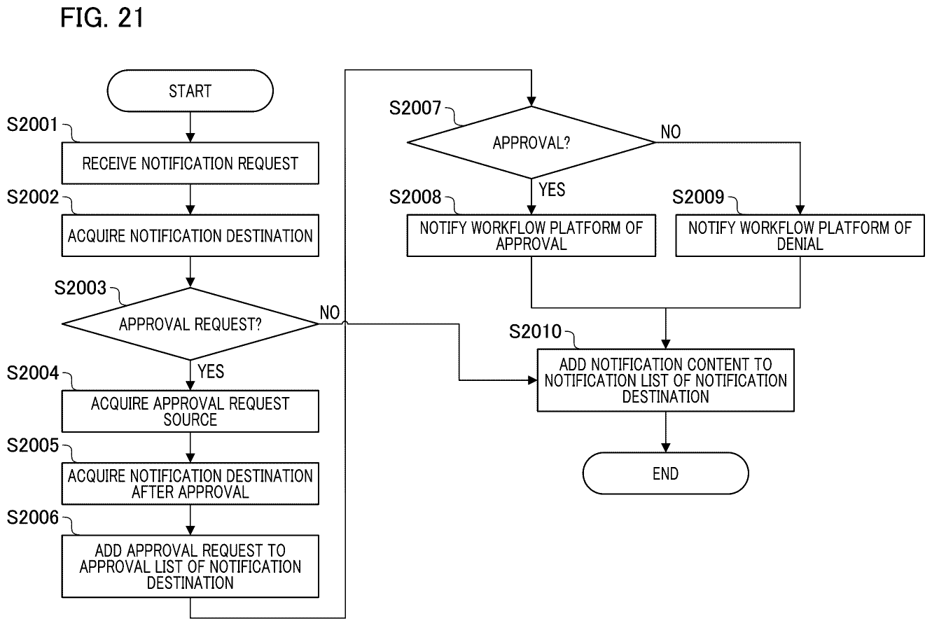

FIG. 21 is a flowchart showing the operation of approval and notification when a workflow in the present system is executed. FIG. 21 is a flowchart of sending and receiving a notification request by a chat service during execution of the workflow according to the first embodiment of the present invention.

In step S2001, the chat service 140 receives a notification request from the workflow platform 130.

In step S2002, the chat service 140 acquires the notification destination included in the notification request that has been received in step S2001.

In step S2003, the chat service 140 determines whether or not the notification request received in step S2001 is an approval request. In a case where the chat service 140 determines that the notification request is an approval request, the process of step S2004 is executed. In a case where the chat service 140 determines that the notification request is not an approval request, the process of step S2010 is executed.

In step S2004, the chat service 140 acquires the request source of the approval request that is the notification request received in step S2001.

In step S2005, the chat service 140 acquires the post-approval notification destination of the approval request that is the notification request received in step S2001.

In step S2006, the chat service 140 adds the approval request to the approval list of the notification destination acquired in step S2002, together with the request source acquired in step S2004 and the post-approval notification destination that has been acquired in step S2005.

Additionally, in step S2006, the chat service 140 changes the display of the badge 510 on the workflow list screen 500 of the client PC 111 that operates the chat service 140. The badge 510 is a badge indicating the number of unprocessed approval notifications that have reached the chat service 140.

In a case where the present number of unprocessed approval notifications is 0, the badge 510 is not displayed, and thus, the chat service 140 displays the badge 510. In a case where the present number of unprocessed approval notifications is other than 0, the badge 510 is displayed, and thus, the chat service 140 increases the number to be displayed in the badge 510 by 1.

The chat service 140 can inform the user that an approval request has been received by displaying the badge 510. Additionally, the chat service 140 may display the notification of the approval request on the notification region of the client PC 111 that operates the chat service 140.

In step S2007, the chat service 140 determines whether or not the added approval request has been approved. In a case where the chat service 140 determines that the approval request has been approved, the process of step S2008 is executed. In a case where the chat service 140 determines that the approval request has not been approved, the process of step S2009 is executed.

In step S2008, the chat service 140 provides a notification of the approval to the workflow platform 130.

In step S2009, the chat service 140 provides a notification of the denial to the workflow platform 130.

In step S2010, the chat service 140 adds the notification content to the notification list of the notification destination. In this case, if the request is not an approval request, the notification result received in response to the notification request is added, and if the request is an approval request, the approval result is added.

In step S2010, the chat service 140 changes the display of the badge 509 on the workflow list screen 500 of the client PC111 that operates the chat service 140. The badge 509 is a badge indicating the number of unread notifications that have reached the chat service 140.

In a case where the present number of unread notifications so far is 0, the badge 509 is not displayed, and thus, the chat service 140 displays the badge 509. In a case where the present number of unread notifications so far is other than 0, the badge 509 is displayed, and thus the chat service 140 increases the number to be displayed in the badge 509 by 1.

The chat service 140 can inform the user that a notification has arrived by displaying the badge 509. Additionally, the chat service 140 may display that there is an unread notification in the notification region of the client PC111 that operates the chat service 140.

By the procedure of FIG. 21, the chat service 140 can display a notification to the user in cooperation with the workflow platform 130.

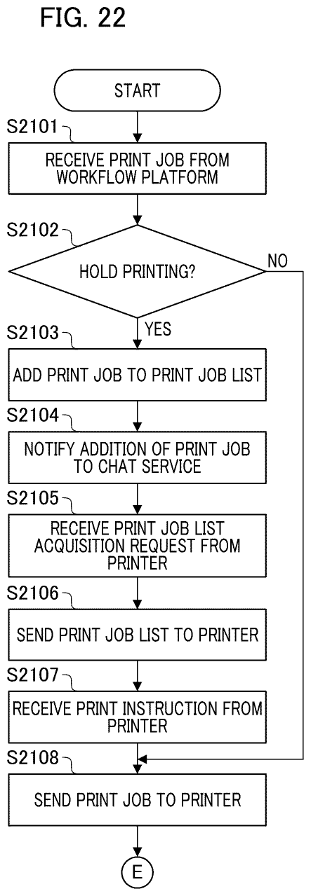

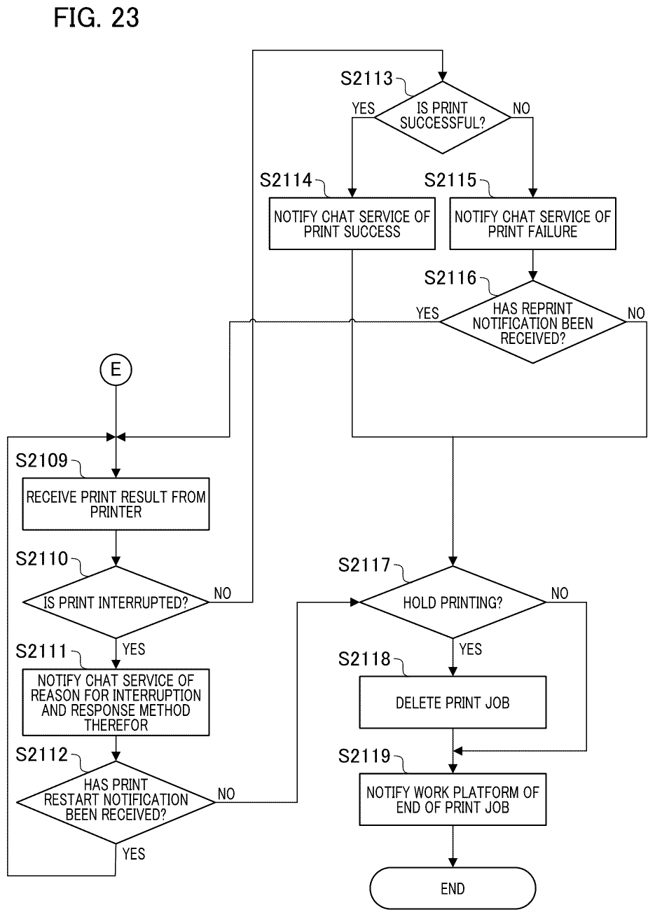

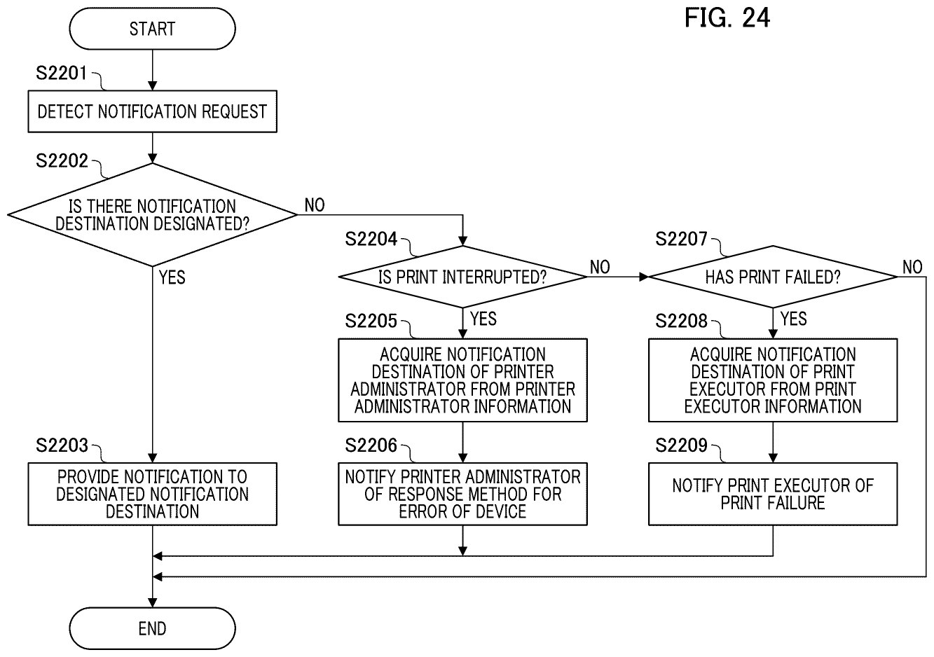

Next, a workflow when notification is performed will be explained, with reference to FIG. 22, FIG. 23 and FIG. 24. FIG. 22 and FIG. 23 are flowcharts of notification by the print service during execution of the workflow according to the first embodiment of the present invention.

The circled alphabetic character as shown in FIG. 22 is connected to the same positions of the circled alphabetic character as shown in FIG. 23. FIG. 24 is a flowchart in which the print service determines the notification destination during execution of the workflow according to the first embodiment of the present invention.

In the present embodiment, in a series of flowcharts, notification is performed up to four times at the time of input of a hold print job (step S2104), at the time of printing interruption (step S2111), at the time of printing success (step S2114), and at the time of printing failure (step S2115).

Although the notification is transmitted from the print service 120, it may be transmitted from the workflow platform 130. Note that in a case where the notification is performed from the workflow platform 130, another process may be performed between the execution of the print job and the notification of the print result, and the result may be reflected in the notification content.

Additionally, the notification may be performed during scanning in addition to printing, and the notification may be performed before or after the execution of the job. For example, the notification content after the execution of the scan job may include data of the result. For example, a request to approve the print contents may be notified before printing, or the printer may be notified that the print job has been held. Note that this embodiment is merely an example, and the processes to be combined, the order of the processes, and the method of acquiring the notification destination are not limited thereto.

FIG. 22 and FIG. 23 are flowcharts of a notification performed in the print service 120 in a case where the print connector is executed in the workflow platform 130. Since steps S2101 to S2103 are similar to steps S1701 to S1703 as described above, the explanation thereof will be omitted here.

In step S2104, the print service 120 provides a print job addition notification to the chat service 140. Since steps S2105 to 2109 are similar to steps 1704 to 1708 as described above, the explanation thereof will be omitted here.

In step S2110, the print service 120 determines whether or not the print result indicates that printing has been interrupted. In a case where the print service 120 determines that printing has been interrupted, the process of step S2111 is executed. In a case where the print service 120 determines that the printing has not been interrupted, the process of step S2113 is executed.

In step S2111, the print service 120 provides a notification of the reason for the interruption and a response method therefor to the chat service 130 and enables restarting printing or ending printing. Note that notification destinations need not be unified in one workflow, and may be individually set according to the purpose of notification. For example, notification destinations of a print executor set as a destination of notification of printing success and a printer administrator who deals with the occurrence of a device error such as ink out and paper jam may be set.

In step S2112, the print service 120 waits for a print restart notification from the chat service 140, and determines whether or not the print restart notification has been received. In step S2112, the print service 120 may receive a print restart notification from the printer 110.

In a case where the print service 120 determines that the print restart notification has been received, the process of step S2109 is executed. In a case where the print service 120 determines that the print restart notification has not been received due to timeout and the like, the process of step S2117 is executed.

In step S2113, the print service 120 determines whether or not the printing is successful. In a case where the print service 120 determines that the printing is successful, the process of step S2114 is executed. In a case where the print service 120 determines that the printing is not successful, the process of step S2115 is executed.

In step S2114, the print service 120 provides a notification of the printing success to the chat service 140. The notification of the print result may be provided to a group of the chat service 140, in addition to the individual address.

In step S2115, the print service 120 provides a notification of the printing failure to the chat service 140, and enables reprinting or ending the print job.

In step S2116, the print service 120 waits for a reprint notification from the chat service 140, and determines whether or not a reprint notification has been received. In step S2116, the print service 120 may receive a reprint notification from the printer 110.

In a case where the print service 120 determines that the reprint notification has been received, the process of step S2109 is executed. In a case where the print service 120 determines that the reprint notification has not been received due to timeout and the like, the process of step S2117 is executed.

In step S2117, the print service 120 determines whether or not hold printing is to be performed. In a case where the print service 120 determines that hold printing is to be performed, the process of step S2118 is executed. In a case where the print service 120 determines that hold printing is not to be performed, the process of step S2119 is executed.

In step S2118, the print service 120 deletes the print job.

In step S2119, the print service 120 provides a notification of the end of the print job to the workflow platform 130, and the process ends.

According to the procedures of FIG. 22 and FIG. 23, the print service 120 can provide notification about the print result in cooperation with the chat service 140.

FIG. 24 is a flowchart of processing related to a method for determining a notification destination in a case where a notification request is generated in step S2104, step S2111, step S2114, and step S2115 in FIG. 22 and FIG. 23.

In step S2201, the print service 120 detects the notification request.

In step S2202, the print service 120 confirms the print job and determines whether or not a notification destination is designated. In a case where the print service 120 determines that the notification destination is designated, the process of step S2203 is executed. In a case where the print service 120 determines that the notification destination is not designated, the process of step S2204 is executed.

In step S2203, the print service 120 transmits the notification to the chat service 140 of the designated notification destination.

In a case where notification destination is not designated, the print service 120 confirms the cause of the notification in step S2204 and subsequent steps.

In step S2204, the print service 120 determines whether or not printing has been interrupted. In a case where the print service 120 determines that printing has been interrupted, the process of step S2205 is executed. In a case where the print service 120 determines that printing has not been interrupted, the process of step S2207 is executed.

In step S2205, the print service 120 acquires the notification destination of the printer administrator in the chat service 140 from the printer administrator information. The printer administrator information is, for example, information managed in the print service 120 by associating information capable of specifying a printer with a notification destination in the chat service 140 of a printer administrator who manages the printer.

In step S2206, the print service 120 provides a notification of a response method for the error causing the print interruption to the notification destination of the printer administrator acquired in step S2205.

In step S2207, the print service 120 determines whether or not printing has

failed. In a case where the print service 120 determines that the printing has failed, the process of step S2208 is executed. In a case where the print service 120 determines that the printing has not failed, the process ends.

In step S2208, the print service 120 acquires the notification destination of the print executor in the chat service 140 from the print executor information. The print executor information is, for example, information managed in the print service 120 by associating information capable of specifying a print job with a notification destination in the chat service 140 of the print executor who has executed the print job.

In step S2209, the print service 120 provides a notification of the print failure to the notification destination of the print executor that has been acquired in step S2208.

Although, in the present embodiment, the notification destination is acquired from the print service 120, an acquisition request for account information may be transmitted to the workflow service 130. In a case where the notification of the print result is not essential, such as a case where the printing is successful or a case where the notification at the time of inputting the hold print job is performed, the notification is not performed, and the process ends.

According to the procedure of FIG. 24, even in a case where a notification destination is not set, an appropriate notification destination can be acquired and notified when an error occurs.

As described above, according to the present embodiment, the workflow platform 130 can print a file using the printer 110 and provide a notification of the print result to the chat service 140 in cooperation with a plurality of services and the print service 120.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the print system and the like through a network or various storage media. Then, a computer (or a CPU, an MPU, or the like) of the print system and the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2023-173182, filed on Oct. 4, 2023, which is hereby incorporated by reference herein in its entirety.

What is claimed is:

1. A print system that performs printing from a workflow comprising:
a workflow platform that executes the workflow;
a chat service that provides notification to a user; and
a print service that performs printing by a printer,
wherein the workflow platform has at least one processor or circuit configured to function as: a workflow construction unit configured to construct the workflow in cooperation with the chat service and the print service, and a workflow execution unit configured to execute the workflow, and
wherein the workflow execution unit executes printing by the print service according to the workflow to be executed, and provides notification of a result of printing executed by the print service by the chat service.

2. The print system according to claim 1, wherein the workflow execution unit provides notification by the chat service during creation of a hold print job.

3. The print system according to claim 1, wherein the workflow execution unit provides notification by the chat service during interruption of printing.

4. The print system according to claim 1, wherein the workflow execution unit provides notification by the chat service in response to success and failure of printing.

5. The print system according to claim 1, wherein the workflow execution unit provides notification to a notification destination of a printer administrator or a print executor in a case where there is no designation of a notification destination in a case of notification by the chat service.

6. The print system according to claim 1, wherein the workflow execution unit determines whether or not a login to the chat service is necessary, and if a login is necessary, the workflow execution unit transmits a login request to the chat service and then communicates with the chat service.

7. The print system according to claim 1, wherein the workflow execution unit transmits an approval notification request to the chat service, and receives a result of the approval notification request via the chat service.

8. The print system according to claim 1, wherein the workflow execution unit provides notification of a result of printing executed by the print service via the chat service.

9. The print system according to claim 8, wherein in a case where a result of printing executed by the print service is interruption, the workflow execution unit provides notification to a printer administrator via the chat service.

10. The print system according to claim 8, wherein in a case where a result of printing executed by the print service is failure, the workflow execution unit provides notification to a print executor via the chat service.

11. The print system according to claim 8, wherein in a case where a result of printing executed by the print service is interruption, the workflow execution unit provides notification of a reason for interruption and a response method via the chat service.

12. The print system according to claim 8, wherein in a case where a result of printing executed by the print service is interruption, a print restart notification is not received, and the printing is hold printing, the workflow execution unit deletes a print job of the printing.

13. The print system according to claim 1, wherein the workflow execution unit executes creation, execution, and approval of the workflow via the chat service.

14. A workflow platform that executes a workflow comprising:
at least one processor or circuit configured to function as:
a workflow construction unit configured to construct the workflow in cooperation with a chat service that provides notification to a user and a print service that performs printing by a printer, and
a workflow execution unit configured to execute the workflow,
wherein the workflow execution unit executes printing by the print service according to the workflow to be executed and provides notification of a result of printing executed by the print service by the chat service.

15. A control method of a print system that performs printing from a workflow,
wherein the print system has a workflow platform that executes the workflow, a chat service that provides notification to a user, and a print service that performs printing by a printer,
wherein the workflow platform has a workflow construction process of constructing the workflow in cooperation with the chat service and the print service, and a workflow execution process of executing the workflow, and
wherein in the workflow execution process, printing is executed by the print service according to the workflow to be executed, and a result of printing executed by the print service is notified by the chat service.
